(19) United States
(12) Patent Application Publication
(10) Pub. No.: US 2025/0237876 A1
(43) Pub. Date: Jul. 24, 2025

(54) Flexible Mounting Structures

(71) Applicant: Apple Inc., Cupertino, CA (US)

(72) Inventors: Christopher Patton, San Jose, CA (US); Chih Jen Chen, San Jose, CA (US); Yinjuan He, San Jose, CA (US)

(21) Appl. No.: 18/839,712

(22) PCT Filed: Feb. 9, 2023
(86) PCT No.: PCT/US23/62302

§ 371 Date: Aug. 19, 2024

Related U.S. Application Data
(60) Provisional application No. 63/321,600, filed on Mar. 18, 2022.

(51) Int. Cl. G02B 27/01

(52) U.S. Cl. CPC G02B 27/0176; G02B 2027/0161

(57) ABSTRACT

A head-mounted device may have a display system that displays images. The images may be supplied to eye boxes for viewing by a user with waveguides that have output couplers. The waveguides may be supported by a head-mounted support structure. The frame may have eyeglass lens openings that each receive one of the waveguides. The waveguides may be located between outer lens elements and inner lens elements. Flexures may be used to attach the waveguides to the head-mounted support structure. The flexures may include two or more rings that are welded together to form two or more springs. The springs may allow the waveguides to move relative to the head-mounted support structure when a force is applied to the head-mounted structure, thereby pre-venting deformation of the waveguides. An elastomeric stress attenuator may be interposed between the waveguides and the support structure to absorb impacts that would otherwise damage the waveguides.

This application claims priority to U.S. provisional patent application No. 63/321,600, filed Mar. 18, 2022, which is hereby incorporated by reference herein in its entirety.

### FIELD

This relates generally to electronic devices, and, more particularly, to electronic devices such as head-mounted devices.

### BACKGROUND

Electronic devices such as head-mounted devices may have optical elements such as lenses. The optical components may be housed in a head-mounted support structure. When one or more forces are applied to the head-mounted support structure (e.g., the head-mounted support structure is dropped), the forces may exert excess stress on the optical components, thereby potentially deforming the optical components.

### SUMMARY

A head-mounted device may have a display system such as a display system based on projectors that provide images. The head-mounted device may have a head-mounted support structure such as a head-mounted eyeglasses frame or other head-mounted structure. Waveguides with output couplers may be mounted in lens openings in the head-mounted frame. The waveguides may receive the images and guide the images to the output couplers, where the images are coupled out of the waveguides towards eye boxes for viewing by a user.

To help ensure that the waveguides are not exposed to excess stress during drop events and other situations where forces are applied to the eyeglasses frame, the waveguides are mounted to the frame using flexures that mechanically decouple the waveguides from the frames.

The flexures may each have two or more stacked rings. The rings may be coupled together in two or more locations to form multiple springs. The springs may provide cushioning to the waveguide in the event that the head-mounted device is unexpectedly dropped or subject to other forces.

### BRIEF DESCRIPTION OF THE DRAWINGS

FIG. 1 is a schematic diagram of an illustrative electronic device such as a head-mounted device in accordance with an embodiment.

FIG. 2 is a top view of an illustrative head-mounted device in accordance with an embodiment.

FIG. 3 is a top view of a portion of an illustrative head-mounted device in which optical components are mounted to a head-mounted support structure in accordance with an embodiment.

FIG. 4 is a top view of an illustrative optical component mounting structure for a head-mounted device in accordance with an embodiment.

FIG. 5 is an exploded view of an illustrative flexure in accordance with an embodiment.

FIG. 6 is a perspective view of an illustrative stress attenuator coupled to a portion of a flexure in accordance with an embodiment.

FIG. 7 is a top view of an illustrative optical component mounting structure integrated into a support structure of a head-mounted device in accordance with an embodiment.

### DETAILED DESCRIPTION

Electronic devices such as head-mounted devices may include optical structures such as eyeglass lenses that are mounted in head-mounted support structures. Display systems having display projectors coupled to waveguides with output couplers may be used to present a user with display images (sometimes referred to as computer-generated images or virtual images) as the head-mounted support structures are worn on the head of a user. The display images may be viewed from eye boxes.

A head-mounted device may be configured to allow a user to view the real world from the eye boxes. An optical system may be used to combine real-world images with display images. For example, an optical system may have lens elements through which real-world objects are viewed. The waveguides of the display system form part of this optical system and may be sandwiched between front and rear lens elements so that display images pass to eye boxes through the rear lens elements. In this way, a head-mounted device may present a user with a mixture of display images and real-world images. Display images may, for example, be overlaid over real-world images.

During drop events or other undesired situations where devices are subjected to excessive force, there is a risk that optical components such as waveguides might be damaged and/or deformed. To help prevent damage, optical components such as waveguides may be mounted in head-mounted support structures using resilient mounting structures such as flexures coupled to each waveguide.

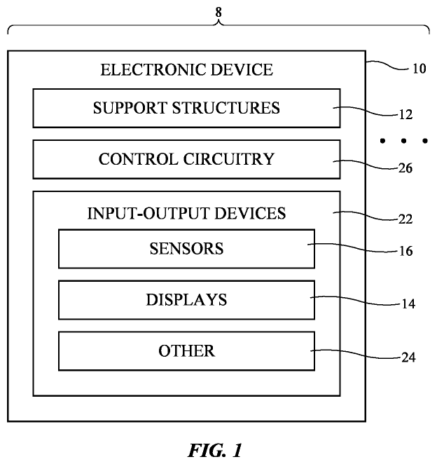

A schematic diagram of an illustrative system that may include a head-mounted device with flexures for mounting lenses is shown in FIG. 1. As shown in FIG. 1, system 8 may include one or more electronic devices such as electronic device 10. The electronic devices of system 8 may include computers, cellular telephones, head-mounted devices, wristwatch devices, and other electronic devices. Configurations in which electronic device 10 is a head-mounted device are sometimes described herein as an example.

As shown in FIG. 1, electronic devices such as electronic device 10 may have control circuitry 12. Control circuitry 12 may include storage and processing circuitry for controlling the operation of device 10. Control circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involving the adjustment of the components of device 10 using control signals, etc.). Control circuitry 12 may include wired and wireless communications circuitry. For example, control circuitry 12 may include radio-frequency transceiver circuitry such as cellular telephone transceiver circuitry, wireless local area network transceiver circuitry (e.g., WiFi® circuitry), millimeter wave transceiver circuitry, and/or other wireless communications circuitry.

During operation, the communications circuitry of the devices in system 8 (e.g., the communications circuitry of control circuitry 12 of device 10), may be used to support communication between the electronic devices. For example, one electronic device may transmit video data, audio data, and/or other data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Device 10 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 1, input-output devices 22 may include one or more displays such as displays 14. In some configurations, device 10 includes left and right display devices (e.g., left and right components such as display projectors based on left and right scanning mirror display devices, liquid-crystal-on-silicon display devices, or digital mirror devices, left and right display panels based on light-emitting diode pixel arrays such as organic light-emitting display panels or display devices based on pixel arrays formed from crystalline semiconductor light-emitting diode dies, liquid crystal display panels, and/or or other left and right display devices that provide images to left and right eye boxes for viewing by the user's left and right eyes, respectively). Illustrative configurations in which device 10 has left and right display devices such as left and right projectors that provide respective left and right display images for a user's left and right eyes through waveguides with output couplers may sometimes be described herein as an example.

During operation, control circuitry 12 uses displays (projectors) 14 to provide visual content for a user of device 10. The content that is presented on displays 14 may sometimes be referred to as display image content, display images, projector images, display projector images, computer-generated content, computer-generated images, virtual content, virtual images, or virtual objects.

Computer-generated images may be combined with real-world images using an optical image combining system. The optical combining system may be used to allow computer-generated content to be optically overlaid on top of a real-world image. For example, device 10 may have an optical system that provides computer-generated images to a user through a waveguide having a holographic output coupler or other optical coupler while allowing the user to view real-world images through the waveguide and optical coupler. The head-mounted support structures of device 10 may form a frame. Device 10 may have left and right projectors supported by left and right sides of the frame. The frame may have lens openings that receive left and right head-mounted device lenses (sometimes referred to as head-mounted device optical components, eyeglass lenses, head-mounted display lenses, or lenses). The lenses may each include a waveguide that serves as part of the optical image combining system. During operation, the waveguides may receive images from the projectors and may convey the images to locations in front of left and right eye boxes where the user's eyes are located. Output couplers on the waveguides such as gratings or holograms may then couple the images out of the waveguides towards the eye boxes. At the same time, a user may view real-world images through the head-mounted device lenses (by viewing the real world from the eye boxes through the waveguides and output couplers that are located in front of the eye boxes).

Input-output circuitry 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors, strain gauges, sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), and/or other sensors.

User input and other information may be gathered using sensors and other input devices in input-output devices 22. If desired, input-output devices 22 may include other devices 24 such as haptic output devices (e.g., vibrating components), light-emitting diodes and other light sources, speakers such as ear speakers for producing audio output, circuits for receiving wireless power, circuits for transmitting power wirelessly to other devices, batteries and other energy storage devices (e.g., capacitors), joysticks, buttons, and/or other components.

Electronic device 10 may have housing structures (e.g., housing walls, straps, etc.), as shown by illustrative support structures 26 of FIG. 1. In configurations in which electronic device 10 is a head-mounted device (e.g., a pair of glasses, goggles, a helmet, a hat, etc.), support structures 26 may include head-mounted support structures (e.g., a helmet housing, head straps, an eyeglass frame, goggle housing structures, and/or other head-mounted structures). The head-mounted support structures may be configured to be worn on a head of a user during operation of device 10 and may support displays 14, sensors 16, other components 24, other input-output devices 22, and control circuitry 12. Configurations in which device 10 has head-mounted support structures that form a frame for a pair of glasses (e.g., a glasses frame, sometimes referred to as an eyeglass frame or head-mounted device frame) are described herein as an example.

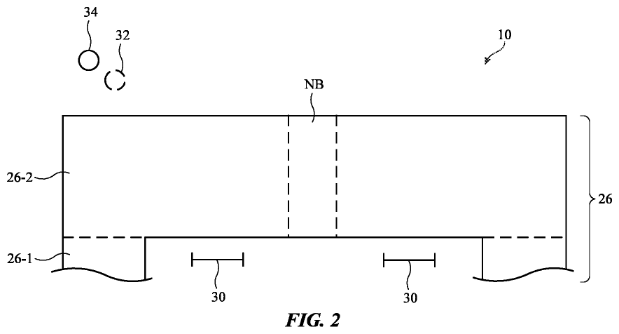

FIG. 2 is a top view of electronic device 10 in an illustrative configuration in which electronic device 10 is a head-mounted device such as a pair of mixed-reality glasses. As shown in FIG. 2, electronic device 10 may include head-mounted support structure 26 to house the components of device 10 and to support device 10 on a user's head. Support structure 26 may include, for example, an eyeglass frame having structures that form housing walls and other structures at the front of device 10 (e.g., support structures 26-2, which may form frame structures at the front of device 10 such as nose bridge NB, a frame structure with rims and/or other structures forming lens openings, end pieces, and/or other housing structures) and additional structures such as straps, temples (sometimes referred to as arms), or other supplemental support structures (e.g., support structures 26-1) that help to hold the front of the frame and the components supported by the front frame portion on a user's face so that the user's eyes are located within eye boxes 30.

During operation of device 10, images are presented to a user's eyes in eye boxes 30. Eye boxes 30 include a left eye box that receives a left image and a right eye box that receives a right image. Device 10 may include a left display system with a left display (projector) 14 that presents the left image to the left eye box and a right display system with a right display (projector) 14 that presents the right image to the right eye box. In an illustrative configuration, each display system may have an optical combiner system (sometimes referred to as an optical combiner assembly, eyeglass lens, head-mounted display lens, etc.) that helps combine display images (e.g., computer-generated image 32 of FIG. 2, sometimes referred to as a virtual image) with real-world images (e.g., light from real-world objects such as object 34 of FIG. 2). Optical combiner systems may, for example, be formed from eyeglass lenses that include waveguides with output couplers formed from holograms. The waveguides may be formed from polymer layers and/or glass layers that transport images internally (e.g., in a waveguide core) in accordance with the principal of total internal reflection.

Displays 14 (e.g., projectors) may be mounted in nose bridge NB, at the outer left and right edges of structures 26-2 (e.g., when device 10 contains respective left and right projectors), and/or in other portions of head-mounted support structures 26. Display images from the displays may be coupled into respective left and right waveguides (e.g., through prisms and/or other input couplers). The waveguides may be formed form transparent layers such as glass or polymer layers (plates, films, etc.) that extend across the front of device 10 and overlap left and right eye boxes 30, respectively. The waveguides may be supported by nose bridge NB, by frame rims in support structures 26-2, and/or using other portions of head-mounted support structures (head-mounted eyeglass frame) 26. Each waveguide may have an embedded output coupler and/or an output coupler that is laminated to the surface of the waveguide structure. Each output coupler may be formed from a hologram, grating, or other optical output coupler structure. During operation, display images from the displays that are coupled into the waveguides travel laterally across the front of device 10 within the waveguides (e.g., image light is guided within the waveguides in accordance with the principal of total internal reflection). When the guided image light reaches the output couplers, the output couplers couple the image light out of the waveguides towards eye boxes 30 for viewing.

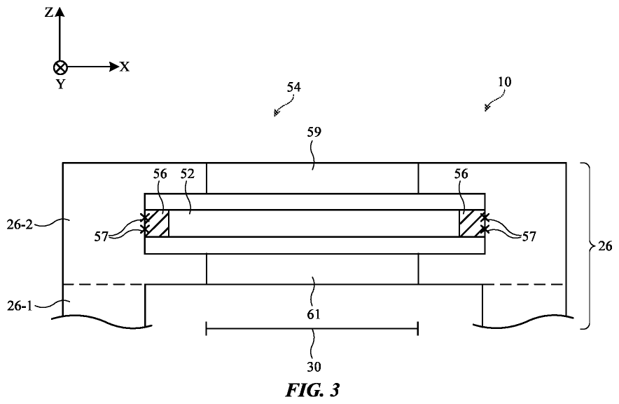

A top cross-sectional view of a portion of an illustrative head-mounted device is shown in FIG. 3. As shown in FIG. 3, device 10 may have a head-mounted support structure (head-mounted frame) 26 with openings that each receive an eyeglass lens 54. (Device 10 preferably has left and right eyeglass lenses 54, but only a single lens 54 is shown in FIG. 3. to avoid over-complicating the drawing).

Each eyeglass lens 54 in device 10 may have a waveguide such as waveguide 52 and additional optical elements. The additional optical elements may include, for example, lens elements. In an illustrative configuration, each lens 54 includes an outer optical element such as outer lens element 59 and an inner optical element such as inner lens element 61. In each eyeglass lens 54, waveguide 52 may be mounted in a groove (e.g., waveguide mounting recess 50) or other waveguide mounting portion of structure 26. Waveguide 52 may be separated from lens elements 59 and 61 by gaps (e.g., so that there are air gaps separating the front lens element from the waveguide and separating the rear lens element from the waveguide). In an illustrative configuration, waveguide 52 may have outer and inner layers (e.g., planar glass layers or planar layers of polymer or other transparent material) and may have a layer of polymer located between the outer and inner glass layers. Other type of waveguide structure may be used in forming waveguide 52, if desired. During operation, the waveguide guides image light internally in accordance with the principal of total internal reflection. In the region of the waveguide that overlaps eye box 30, the polymer may be patterned to form an associated output coupler that couples guided display image light out of the waveguide towards the eye box.

If desired, inner lens element 61 of eyeglass lens 54 may have a negative bias component and a user-specific eyeglass prescription component, whereas outer lens element 59 may have a positive bias component that is equal and opposite to that of the negative bias component. As an example, the outer lens element may have a +1 diopter bias component and the inner lens element may have a −1 diopter bias component. When viewing real-world images through lens 54 from eye box 30, these two bias components cancel each other. If a user has a vision defect (e.g., nearsightedness or farsightedness), vision correction can be implemented by combining a user's prescription with the negative bias component of inner lens element 61. Otherwise, inner lens element 61 may include only the negative bias component, which may help to establish a desired virtual image distance for the virtual images being presented to the user in eye box 30. Arrangements in which the inner and/or outer elements of lens 54 are formed from planar transparent protective layers (e.g., a glass element with no lens power) may be used, if desired.

The optical components of each lens 54 may be attached to head-mounted support structure 26 using any suitable arrangement (e.g., using gaskets, adhesive, press-fit connections, mating engagement features, etc.). In an illustrative configuration, waveguide 52 is coupled to support structures 26 using a peripheral waveguide mounting structure 56 that serves as a flexure. Structure 56 may be formed from metal structures, polymer structures, and/or other structures that form a resilient mounting structure such as a flexure. The flexure may include fingers at locations along the peripheral edge of waveguide 52 that serve as springs. In the event that device 10 is dropped or otherwise subjected to excessive force, the springs can stretch, thereby allowing the flexure to elastically deform to cushion the impact. This helps prevent excessive stress from being conveyed from support structures 26 to waveguide 52 and thereby helps prevent deformation of waveguide 52 and helps prevent damage to waveguide 52 (e.g., cracks and other damage that could develop in waveguide 52 when device 10 is subjected to an undesired drop event can be avoided). The presence of structure 56 mechanically decouples waveguide 52 from structures 26. This allows waveguide 52 to float relative to structures 26 and thereby helps reduce stresses that might adversely affect the planarity of waveguide 52. By preserving waveguide planarity and avoiding cracks and other damage, the presence of structure 56 can help ensure that device 10 operates satisfactorily.

Structure 56 may be attached to support structures 26 using attachment mechanisms 57 (e.g., adhesive, mating engagement features such as posts or other protrusions and mating openings or other recesses configured to receive the protrusions, fasteners, welds, etc.). Attachment mechanisms 57 may be formed using structures on the inner surfaces of the mounting groove or other mounting portion of structure 26, using structures on structure 56, and/or using other attachment structures.

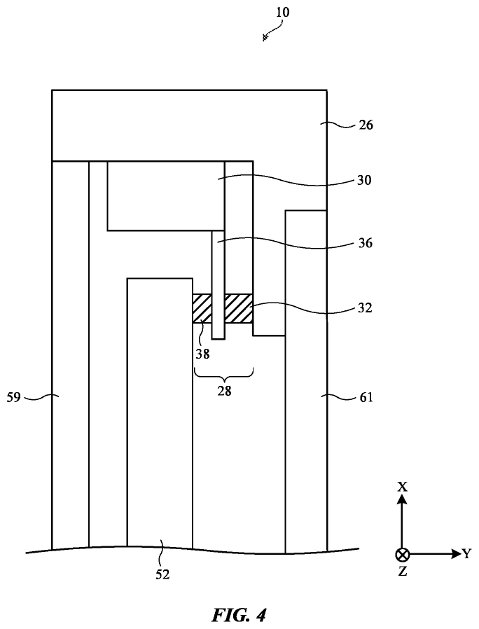

A cross-sectional view of a single waveguide is shown in FIG. 4. As shown in FIG. 4, waveguide 52 may be mounted to support structure 26 between lens elements 59 and 61. In particular, waveguide 52 may be coupled to flexure 28, which in turn may be coupled to support structure 26. Adhesive 38 may couple flexure 28 to waveguide 52, and adhesive 32 may couple flexure 28 to support structure 26. Adhesives 38 and 32 may be any desired type of adhesives, such as pressure-sensitive adhesives (PSAs).

Portion 36 of flexure 28 may be coupled to stress attenuator 30. Stress attenuator 30 may be, for example, an elastomeric member or other flexible member (e.g., a bumper, foam member, cushion, spacer, etc.) that absorbs impacts from waveguide 52. With this mounting arrangement, waveguide 52 may move in the X and Y directions relative to support structure 26 when force is applied to support structure 26. In this way, waveguide 52 may move, rather than deform, in response to force applied to the head-mounted device.

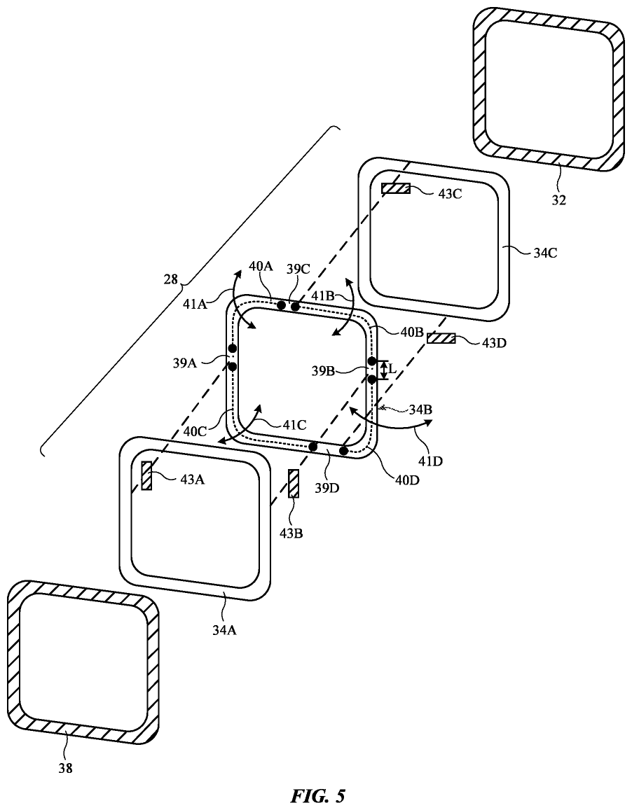

Flexure 28 may have any desired arrangement, but generally may include a stack of one or more rings that are coupled together to form springs that allow waveguide 52 to move in multiple directions. A detailed exploded view of one arrangement of flexure 28 is shown in FIG. 5.

As shown in FIG. 5, flexure 28 may include first ring 34A, second ring 34B, and third ring 34C (sometimes referred to herein as ring structures, ring members, flexure rings, flexure ring structures, or flexure ring members). In particular, first ring 34A may be coupled to waveguide 52 with adhesive ring 38. Third ring 34C may be coupled to support structure 26 with adhesive ring 32. Second ring 34B may be interposed between first ring 34A and third ring 34C. Rings 34A, 34B, and 34C may be formed from metal, composite material, or any other desired material.

Second ring 34B may be coupled to both first ring 34A and third ring 34C. In one example, as shown in FIG. 5, first ring 34A may be coupled to second ring 34B at two points 39A and 39B. Third ring 34C may be coupled to second ring 34B at two points 39C and 39D. As shown in FIG. 5, first ring 34A and third ring 34C may be coupled to second ring 34B with welds, such as laser welds, 43A, 43B, 43C, and 43D. Welds 43A and 43B or other couplings at points 39A and 39B (i.e., between first ring 34A and second ring 34B) may be offset welds 43C and 43D or other couplings at points 39C and 39D (i.e., between third ring 34C and second ring 34B) by approximately 900 or other angles. This arrangement configures second ring 34B to form four springs 40A, 40B, 40C, and 40D having endpoints defined by points 39A, 39B, 39C, and 39D. In addition to the X and Y motion described in connection with FIG. 4, springs 40A, 40B, 40C, and 40D may allow for rotational movement, as indicated by arrows 41A, 41B, 41C, and 41D, respectively. As a result, springs 40 may allow waveguide 52 to move relative to support structure 26 with six degrees of freedom in response to a force on support structure 26. Springs 40A, 40B, 40C, and 40D may sometimes also be referred to herein as spring members or spring structures. In a steady state in which no external forces are applied to the flexure, springs 40A, 40B, 40C, and 40D may lie in a common or shared plane (e.g., may be coplanar).

Although FIG. 5 shows flexure 28 including three rings and four springs, this is merely illustrative. In general, flexure 28 may include any desired number of rings and/or springs (e.g., based on the number of welds between the rings). For example, flexure 28 may include a stack of two rings, three rings, four rings, or more than four rings, which may be welded or otherwise coupled together to form two springs, three springs, four springs, or more than four springs.

Moreover, although FIG. 5 shows a weld length L between springs, this length is merely illustrative. For example, if it is desired for waveguide 52 to move less within the head-mounted device when external forces are applied, weld length L may be increased to increase the spring rate or spring force (e.g., spring coefficient) of the springs in ring 34B. Alternatively, if it is desired for waveguide 52 to move more within the head-mounted device, weld length L may be decreased to decrease the spring rate of the springs in ring 34B. In general, any desired weld length L may be used between springs 40. Each of the welds may have different weld lengths if desired. In other words, springs 40A, 40B, 40C, and 40D may each have the same length or may have different lengths as needed to prevent unwanted motion of waveguide 52.

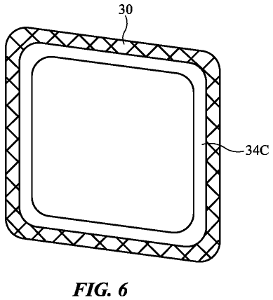

Due to the motion of waveguide 52 allowed by flexure 28, stress attenuator 30 may be included to dampen impacts of waveguide 52 against support structure 26 (see FIG. 4). An example of stress attenuator 30 is shown in FIG. 6.

As shown in FIG. 6, stress attenuator 30 may be coupled to third ring 34C. For example, stress attenuator 30 may be overmolded on third ring 34C. However, any desired attachment mechanism may be used to attach stress attenuator 30 within support structure 26.

Stress attenuator 30 may be any desired flexible/shock absorbent material, such as an elastomer. In this way, stress attenuator 30 may absorb impacts of waveguide 52 when it moves relative to support structure 26 (i.e., in the X direction in FIG. 4). This may prevent damage to waveguide 52 that would deteriorate the optical performance of waveguide 52.

Although FIG. 6 shows stress attenuator 30 coupled to third ring 34C, this is merely illustrative. Stress attenuator 30 may be coupled to any other portion of flexure 28, such as first ring 34A or second ring 34B, or may otherwise be implemented within support structure 26. For example, stress attenuator 30 may be separate from flexure 28 and be interposed between waveguide 52 and support structure 26 to absorb impacts when waveguide 52 moves.

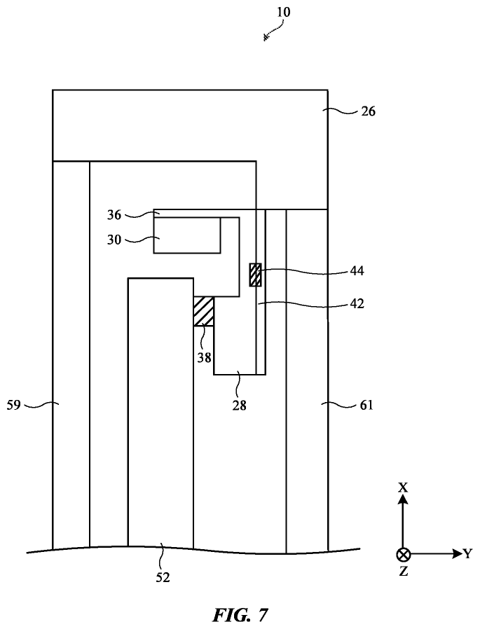

Although FIGS. 4-6 have described flexure 28 as having three rings, one of which (third ring 34C) couples flexure 28 to support structure 26, this arrangement is merely illustrative. If desired, a portion of flexure 28 may be formed from support structure 26 or another structure within the head-mounted device. An example of this arrangement is shown in FIG. 7.

As shown in FIG. 7, flexure 28 may be coupled to frame 42, which extends from support structure 26, via weld 44. In this arrangement, third ring 34C may be omitted from flexure 28, and second ring 34C may be directly welded or otherwise attached to frame 42 with weld 44. For example, second ring 34B may be welded to frame 42 at points 39C and 39D, as discussed above in connection with FIG. 5. However, as previously discussed, any desired number of welds may be made between second ring 34B and frame 42 at any desired locations along second ring 34B.

Portion 36 of flexure 38 may be a portion of second ring 34B. Stress attenuator 30 may be coupled to portion 36 to prevent damage to waveguide 52 as it moves toward support structure 26.

Although the foregoing embodiments describe the use of flexure 28 in connection with a waveguide in a head-mounted device, this is merely illustrative. In general, flexure 28 may be a flexible member that includes two or more ring members and two or more springs. In this way, the flexible member may allow a first component (to which one of the rings is attached) to move relative to another component (to which another one of the rings is attached).

In accordance with an embodiment, a head-mounted device is provided that includes a projector configured to produce an image, a support structure having an opening, a waveguide configured to receive the image and guide the image to an output coupler that couples the image out of the waveguide and a flexure that couples the waveguide to the support structure, the flexure includes a first ring and a second ring coupled to the first ring, the first ring being interposed between the waveguide and the second ring.

In accordance with another embodiment, the head-mounted device includes a third ring coupled to the second ring, the second ring is interposed between the first ring and the third ring.

In accordance with another embodiment, the third ring is coupled to the support structure and the first ring is coupled to the waveguide.

In accordance with another embodiment, the head-mounted device includes a first ring of adhesive that attaches the first ring and the waveguide and a second ring of adhesive that attaches the third ring to the support structure.

In accordance with another embodiment, the first ring is welded to the second ring at a first point and at a second point.

In accordance with another embodiment, the third ring is welded to the second ring at a third point and at a fourth point, and the second ring forms a first spring between the first point and the third point, a second spring between the third point and the second point, a third spring between the second point and fourth point, and a fourth spring between the fourth point and the first point.

In accordance with another embodiment, the welds at the first point, the second point, the third point, and the fourth point include laser welds.

In accordance with another embodiment, the head-mounted device includes a stress attenuator overmolded on a portion of the flexure.

In accordance with another embodiment, the head-mounted device includes a frame that extends from the support structure, the second ring is coupled to the frame.

In accordance with another embodiment, the second ring is welded to the frame.

In accordance with another embodiment, the head-mounted device includes a stress attenuator coupled to a portion of the second ring.

In accordance with an embodiment, a flexible component for coupling a first element to a second element, the flexible component is provided that includes a first ring structure, a second ring structure, the first ring structure is welded to the second ring structure at a first point and at a second point and a third ring structure welded to the second ring structure at a third point and at a fourth point, the second ring structure forming a first spring between the first point and the third point, a second spring between the third point and the second point, a third spring between the second point and fourth point, and a fourth spring between the fourth point and the first point.

In accordance with another embodiment, the welds at the first point, the second point, the third point, and the fourth point include laser welds.

In accordance with another embodiment, the first and second springs are separated by a first distance, and the third and fourth springs are separated by a second distance that is the same as the first distance.

In accordance with another embodiment, the first and second springs are separated by a first distance, and the third and fourth springs are separated by a second distance that is different from the first distance.

In accordance with an embodiment, a head-mounted device is provided that includes a projector configured to produce an image, a support structure having an opening, a waveguide configured to receive the image and guide the image to an output coupler that couples the image out of the waveguide, a flexible component that couples the waveguide to the support structure and a stress attenuator overmolded on a portion of the flexible component.

In accordance with another embodiment, the flexible component includes first and second rings, and the stress attenuator is overmolded on a portion of the second ring.

In accordance with another embodiment, the second ring is attached to a portion of the support structure.

In accordance with another embodiment, the flexible component includes first, second, and third rings, the second ring is interposed between the first and third rings, and the first and third rings are coupled to the second ring to form springs in the second ring.

In accordance with another embodiment, the springs in the second ring allow the second ring and waveguide to move rotationally.

The foregoing is merely illustrative and various modifications can be made to the described embodiments. The foregoing embodiments may be implemented individually or in any combination.

What is claimed is:

1. A head-mounted device, comprising:
a projector configured to produce an image;
a support structure having an opening;
a waveguide configured to receive the image and guide the image to an output coupler that couples the image out of the waveguide; and
a flexure that couples the waveguide to the support structure, wherein the flexure comprises a first ring and a second ring coupled to the first ring, the first ring being interposed between the waveguide and the second ring.

2. The head-mounted device of claim 1, further comprising:
a third ring coupled to the second ring, wherein the second ring is interposed between the first ring and the third ring.

3. The head-mounted device of claim 2, wherein the third ring is coupled to the support structure and the first ring is coupled to the waveguide.

4. The head-mounted device of claim 3, further comprising:
a first ring of adhesive that attaches the first ring and the waveguide; and
a second ring of adhesive that attaches the third ring to the support structure.

5. The head-mounted device of claim 4, wherein the first ring is welded to the second ring at a first point and at a second point.

6. The head-mounted device of claim 5, wherein the third ring is welded to the second ring at a third point and at a fourth point, and wherein the second ring forms a first spring between the first point and the third point, a second spring between the third point and the second point, a third spring between the second point and fourth point, and a fourth spring between the fourth point and the first point.

7. The head-mounted device of claim 6, wherein the welds at the first point, the second point, the third point, and the fourth point comprise laser welds.

8. The head-mounted device of claim 6, further comprising:
a stress attenuator overmolded on a portion of the flexure.

9. The head-mounted device of claim 1, further comprising:
a frame that extends from the support structure, wherein the second ring is coupled to the frame.

10. The head-mounted device of claim 9, wherein the second ring is welded to the frame.

11. The head-mounted device of claim 9, further comprising:
a stress attenuator coupled to a portion of the second ring.

12. A flexible component for coupling a first element to a second element, the flexible component comprising:
a first ring structure;
a second ring structure, wherein the first ring structure is welded to the second ring structure at a first point and at a second point; and
a third ring structure welded to the second ring structure at a third point and at a fourth point, the second ring structure forming a first spring between the first point and the third point, a second spring between the third point and the second point, a third spring between the second point and fourth point, and a fourth spring between the fourth point and the first point.

13. The flexible component of claim 12, wherein the welds at the first point, the second point, the third point, and the fourth point comprise laser welds.

14. The flexible component of claim 12, wherein the first and second springs are separated by a first distance, and the third and fourth springs are separated by a second distance that is the same as the first distance.

15. The flexible component of claim 12, wherein the first and second springs are separated by a first distance, and the third and fourth springs are separated by a second distance that is different from the first distance.

16. A head-mounted device, comprising:
a projector configured to produce an image;
a support structure having an opening;
a waveguide configured to receive the image and guide the image to an output coupler that couples the image out of the waveguide;
a flexible component that couples the waveguide to the support structure; and
a stress attenuator overmolded on a portion of the flexible component.

17. The head-mounted device of claim 16, wherein the flexible component comprises first and second rings, and wherein the stress attenuator is overmolded on a portion of the second ring.

18. The head-mounted device of claim 17, wherein the second ring is attached to a portion of the support structure.

19. The head-mounted device of claim 16, wherein the flexible component comprises first, second, and third rings, the second ring is interposed between the first and third rings, and the first and third rings are coupled to the second ring to form springs in the second ring.

20. The head-mounted device of claim 19, wherein the springs in the second ring allow the second ring and waveguide to move rotationally.
